(19) United States
(12) Patent Application Publication
(10) Pub. No.: US 2001/0038344 A1
(43) Pub. Date: Nov. 8, 2001

(54) Alarm system responding to presence of an emergency vehicle

(76) Inventor: Anthony M. Garcia, North Hills, CA (US)

Correspondence Address: ROBERT J. SCHAAP, Suite 188, 21241 Ventura Boulevard, Woodland Hills, CA, 91364-2109, US

(21) Appl. No.: 09/848,760

(22) Filed: May 2, 2001

Related U.S. Application Data
(60) Provisional application No. 60/201,835, filed on May 3, 2000.

(51) Int. Cl. G08G 1/00

(52) U.S. Cl. 340/902; 340/904; 340/539; 340/531

(57) ABSTRACT

An alarm system for alerting drivers and passengers of a non-emergency vehicle to the approximate presence of an emergency vehicle which may be approaching the particular non-emergency vehicle. In one embodiment, an alarm, such as a blinking light or the like, is generated within the non-emergency vehicle or non-emergency vehicles. In another embodiment, a positioning system is also provided and displays the approximate position of the emergency vehicle, such that the driver or passengers of the non-emergency vehicle or vehicles may be apprised of the presence of and approximate location and direction of that emergency vehicle.

### BACKGROUND OF THE INVENTION

1. Field of the Invention

This invention relates in general to certain new and use improvements in alarm systems responding to the presence of an emergency vehicle and, more particularly, to an alarm system which generates an alarm within non-emergency vehicles in the proximity of that emergency vehicle so that the driver and/or passengers of the non-emergency vehicle may be alerted to the presence of that emergency vehicle.

2. Brief Description of Related Art

In recent years, the number of collisions which have arisen between standard passenger automotive vehicles and trucks with emergency vehicles, such as, for example, ambulances, fire trucks, police cars and the like, have increased substantially. This is due, at least in part, to a higher density of standard automotive vehicles for the given amount of vehicle traffic space. In addition, there is a great amount of pedestrian traffic using the same vehicle roads, particular for crossing of those roads.

As a result of these conditions, it has been established that one of the more dangerous occupations is that of driving an emergency vehicle, such as an ambulance, police car, or the like. The driver of the emergency vehicle is frequently anxious to arrive at a destination where help may be required from the personnel in that vehicle. The driver of the emergency vehicle is therefore frequently distracted by the need to arrive at this destination and also the frequent communications with a fixed local central station.

Drivers of the emergency vehicles will frequently attempt to cross major and busy intersections where traffic is normally fairly heavy, operating on the assumption that their siren and flashing lights will warn other drivers of the proximity of the emergency vehicle. This assumption can and, not infrequently, does lead to additional collisions and the resultant injuries and deaths which can arise in any collision.

The increase in the amount of traffic has also been accompanied by an increase in the sealing capabilities in passenger automotive vehicles. Many automobile passengers, for example, are desirous of obtaining automobiles which are not only luxurious but are relatively sound proof to eliminate road noise and traffic noise. As a result, many drivers and passengers will roll up the windows of the vehicle and rely upon the internal vehicle ventilation system for proper air temperature and humidity conditions, while listening to some sound generating device, such as a radio, CD player, television, or the like. Due to the fact that the vehicle has efficient sound insulation capability, the driver of the vehicle will frequently not hear an emergency vehicle in the proximity of the non-emergency vehicle and frequently may not see the flashing lights of that emergency vehicle until the emergency vehicle is in very close proximity to the particular non-emergency vehicle. In the case of an emergency vehicle approaching from a side street, in which vision is blocked by buildings or other structure, the non-emergency vehicle may not see the emergency vehicle and, for that matter, the driver of the emergency vehicle may not observe the non-emergency vehicle until it is almost too late to avoid a collision.

It is painfully apparent that when an emergency vehicle has a collision with a non-emergency vehicle, not only is there frequently resultant injury to the personnel in both vehicles, there are occasional deaths arising out of these collisions. Moreover, the emergency situation to which the personnel in the emergency vehicle were traveling remains unattended until another emergency vehicle or perhaps other emergency vehicles can be dispatched to the scene of the emergency situation. As a result, the consequences of collisions with an emergency vehicle, whether arising from the inattentiveness or lack of care of the driver of the non-emergency vehicle, or from the anxiousness of the driver of the emergency vehicle, is not only costly to society in general, it results in accidents and fatalities which could otherwise be eliminated if there were an available system to alert the driver of the non-emergency vehicle of the proximity of an approaching emergency vehicle. This is particularly true when the emergency vehicle approaches the non-emergency vehicle from the rear of the non-emergency vehicle.

Many drivers of automotive vehicles are hearing impaired individuals, including some who are profoundly deaf. Nevertheless, they are capable drivers but merely lack the capability of hearing, at least to the same degree as a individual with normal hearing. However, the only available sensory capability for detecting the presence of an emergency vehicle is that of sight. Again, and as indicated, if the emergency vehicle or, for that matter, if the non-emergency vehicle is driving in an area in which the emergency vehicle is not observable, until perhaps an intersection, it may be too late to avoid a collision.

There has been a need for a system to alert the drivers of non-emergency vehicles in the proximity of an emergency vehicle of the presence of that emergency vehicle. In this way, the driver of the non-emergency vehicle can be apprised of the close proximity of a rapidly approaching emergency vehicle and at least stop or take other evasive action to avoid interference with the driving conditions for the emergency vehicle. In this way, there can be an attendant reduction in accidents and potential further injury which will further make the occupation of driving the emergency vehicles a safer occupation.

### OBJECTS OF THE INVENTION

It is, therefore, one of the primary objects of the present invention to provide an emergency vehicle alarm system which is capable of apprising the driver of a non-emergency vehicle of a close proximity of an approaching emergency vehicle.

It is another object of the present invention to provide an emergency vehicle alarm system of the type stated in which an alarm is generated at the non-emergency vehicle in order to apprise the driver of the non-emergency vehicle of a closing proximity of an emergency vehicle, thereby allowing the driver of the non-emergency vehicle to take an evasive action.

It is a further object of the present invention to provide an emergency vehicle alarm system of the type stated which is effective to alert a driver, and perhaps passengers, of an non-emergency automotive vehicle of the presence of an emergency vehicle is close proximity thereto, notwithstanding the existence of a well sound insulated vehicle and notwithstanding the presence of view obstruction which might preclude observation of that emergency vehicle.

It is an additional object of the present invention to provide an emergency vehicle alarm system of the type stated which can be constructed at a relatively low cost and which is also easily installed in existing vehicles and in new automotive vehicle constructions.

It is another salient object of the present invention to provide a method of alerting a driver of a non-emergency vehicle of the presence of an approaching emergency vehicle to enable the driver of the non-emergency vehicle to take other evasive action, such as pulling his or her non-emergency vehicle to the side of a road.

With the above and other objects in view, my invention resides in the novel features of form, construction, arrangement and combination of parts and components presently described and pointed out in the claims.

### BRIEF SUMMARY OF THE INVENTION

The present invention relies in broad terms upon the use of an alarm system in or associated with a non-emergency vehicle and which is interactive with emergency vehicles through wireless communication by transmission of signals between the vehicles which allow for generation of an alarm signal in the non-emergency vehicle. More particularly, the present invention relies upon the use of a transceiver arrangement in which a transmitter of one vehicle activates a receiver in another vehicle, such as a non-emergency vehicle, causing an initiation of an alarm in or in close proximity to that non-emergency vehicle. This will allow the driver of the non-emergency vehicle to take that necessary precautionary or evasive action to avoid any collision with a rapidly approaching emergency vehicle, even though the latter may not be observable at the moment.

More specifically, the present invention relies upon a transmitter in an emergency vehicle which transmits an emergency vehicle wireless communication signal which can be received by all other non-emergency vehicles and, for that matter, by other emergency vehicles, within a close proximity of the particular emergency vehicle generating the signal. This wireless signal may adopt the form of a radio wave signal in a non-carrying band. A receiver in each of the non-emergency vehicles which are equipped with the system of the invention would be automatically activated by receipt of this emergency vehicle signal and thereby initiate either an audible alarm or a visible alarm, or both. The alarm mechanism in the non-emergency vehicle could be conveniently mounted in or on the dashboard of that vehicle in direct view of the driver of the non-emergency vehicle. In this way, the driver of the non-emergency vehicle would have immediate observation of or be within immediate hearing distance of an alarm signal, thereby apprising the driver of a non-emergency vehicle of the close proximity of the approaching emergency vehicle.

In another embodiment of the invention, the alarm system could be used in combination with a display screen and a global positioning arrangement. In this case, a signal from the non-emergency vehicle could be transmitted to a satellite causing the satellite to generate a widely broadcast signal to vehicles in proximity of the emergency vehicle. This broadcast would provide a standard GPS or ground positioning system signal to the non-emergency vehicles enabling the latter to display the presence of the emergency vehicle. The ground positioning system in the vehicle could also be equipped with a computerized grid map so that the driver of the non-emergency vehicle could actually observe the position of the approaching emergency vehicle on a street grid map. Even in the absence of a grid map, the ground positioning signal would at least show the relationship of the emergency vehicle and the non-emergency vehicle.

The present invention also discloses a unique circuit for causing the initiation of the alarm in the non-emergency vehicle. This circuit could be operated through the electrical circuit of the vehicle itself.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a schematic view showing an emergency vehicle and non-emergency vehicles equipped with an alarm system in accordance with the present invention;

FIG. 2 is a schematic plan view showing a portion of a dashboard of a non-emergency vehicle which is equipped with an alarm system of the invention;

FIG. 3 is a schematic plan view of an alternate embodiment of the invention which also incorporates position identification of the emergency vehicle;

FIG. 4 is a schematic plan view of a portion of a dashboard of a non-emergency vehicle equipped with the system of FIG. 3;

FIG. 5 is a schematic block diagram circuit view of the circuit used with the system of FIGS. 3 and 4;

FIG. 6 is a schematic electrical circuit diagram showing the coder which is used with the circuit of the present invention;

FIG. 7 is a schematic electrical circuit diagram of a transmitter which may be used with the present invention; and

FIG. 8 is a schematic electrical circuit diagram of a decoder which is used with the circuit of the present invention.

### DETAILED DESCRIPTION OF PREFERRED EMBODIMENTS

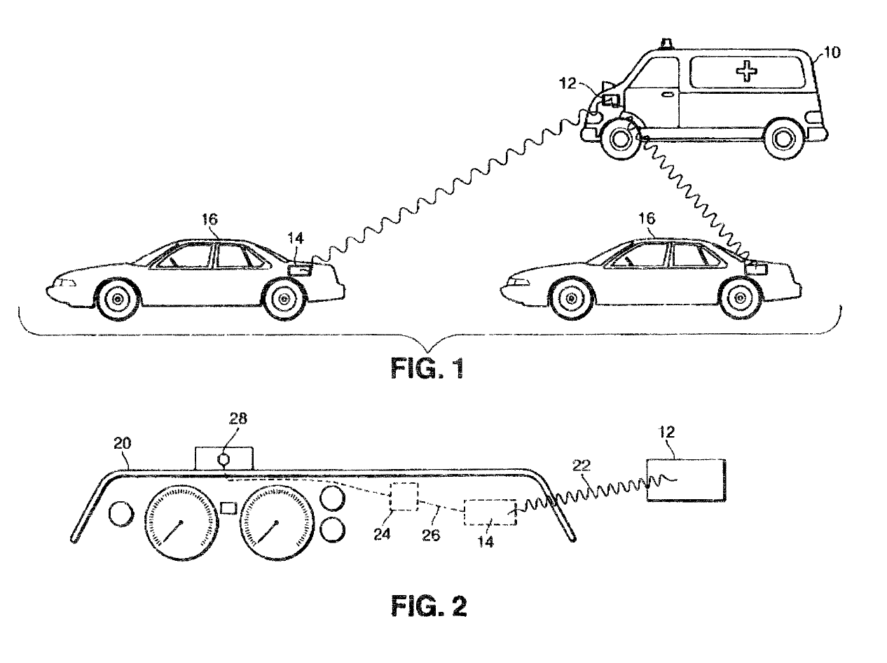

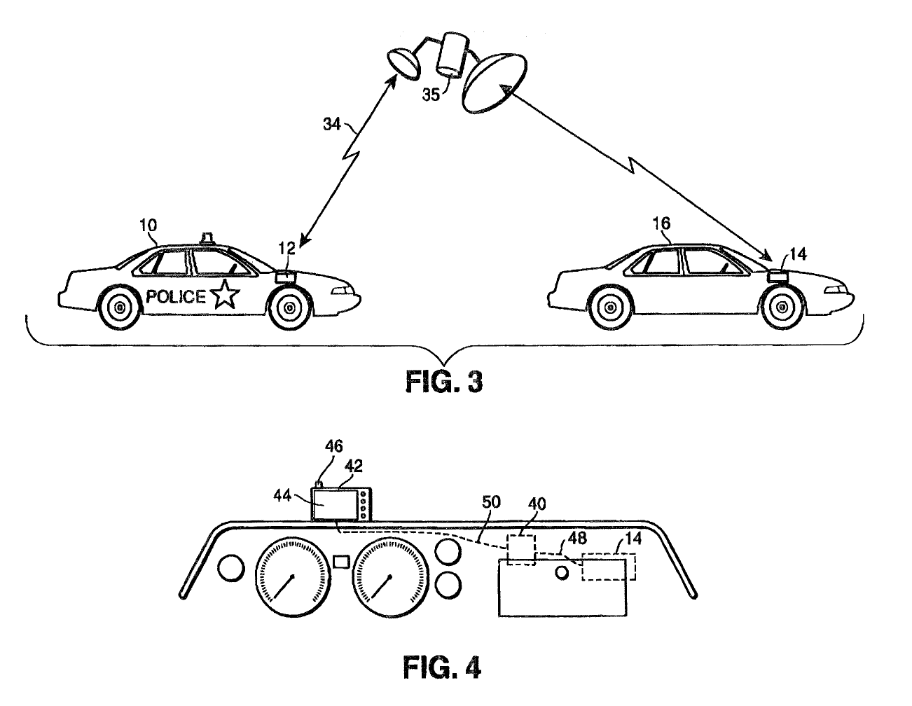

Referring now in more detail and by reference characters to the drawings, which illustrate preferred embodiments of the invention, FIGS. 1 and 2 designate an emergency vehicle alarm system which only generates an alarm signal for the inside passenger compartment of non-emergency vehicles in order to enable the passengers and driver of those non-emergency vehicles to detect the presence of a proximate emergency vehicle in an emergency situation. FIGS. 3 and 4 of the invention more fully illustrate a similar system, but which is also provided with the addition of a ground positioning system in order to enable identification of the location of the emergency vehicle on a display screen observable to the drivers of the non-emergency vehicles.

Referring now to FIG. 1, it can be seen that there is an emergency vehicle 10 which is equipped with a transmitter 12 for activating a sound or light emergency warning signal 14 in one or more non-emergency vehicles 16. Thus, in this way, if the driver or passengers of a non-emergency vehicle 16 are in the presence of an emergency vehicle being operated in an emergency condition, the transmitter 12 of the emergency vehicle will generate an airborne signal which activates the receiver 14 in the non-emergency vehicles 16.

In general, the signal from the emergency vehicle, such as the vehicle 10, will generally be a radio wave signal. However, other air wave signals could be used. Moreover, the signal issued by the emergency vehicle will normally be a coded signal so as to preclude interference with radio operated equipment of other vehicles and of the emergency vehicle and to preclude any other type of interference. In this respect, the emergency vehicle would be equipped with an encoder for encoding the signal and the non-emergency vehicles would be equipped with decoders for decoding that airborne signal from the emergency vehicle.

FIG. 2 shows a dashboard 20 in the interior of a non-emergency vehicle. The components forming part of the emergency vehicle alarm system of the invention are shown as being schematically mounted on and also beneath the surface of the dashboard 20 of that vehicle. However, it should be understood that these various components could all be mounted within the dashboard or at any other suitable convenient location within the automotive vehicle.

In accordance with the arrangement of FIG. 2, the transmitter 12 of the emergency vehicle is shown to the right of and spaced apart from the dashboard 20 and is also shown as generating an airborne signal 22. The receiver 14 in the non-emergency vehicle is shown as being mounted within the dashboard 20 of the vehicle 16 and out of sight. In this case, the receiver 14 is connected to a simple amplifier 24 also shown as being mounted on the dashboard by means of an electrical conductor, and which is connected to the receiver by means of a conductor 26. The output of the amplifier 24 is thereupon connected to an alarm device 28 which may be in the nature of a light signal alarm device or a sound generating device, or both. This alarm signal generating device 28 is similarly shown as being mounted on the dashboard 20.

In the embodiment of the invention as shown in FIG. 2, the receiver 14 and the amplifier 24 along with the conductor 26 have been shown as being mounted within the dashboard of the vehicle. This is only for purposes of illustrating the principles of the invention. However, it should be understood that these components could be mounted at any convenient location in the vehicle and not necessarily within the dashboard of the vehicle. Although not shown, it should also be understood that these electrically components would be connected to the electrical power system of the automotive vehicle. It is possible to operate these components through a battery system apart from the circuit of the vehicle, although the latter would not necessarily be practical, as such.

It should be recognized that if the alarm signal generated inside of the non-emergency vehicle is a sound signal, then the signal generating device 28 can be located at any convenient location within the vehicle. However, if it is a light signal advising of the presence of an emergency vehicle, then it would have to be located in approximate presence and within the eyesight of the driver of the vehicle, thereby enabling the driver to take a precautionary action.

In connection with the embodiment of the invention, as shown in FIGS. 1 and 2, there is no need for a complex control system. It is only necessary to receive the signal from the receiver 14 and amplify that signal for operating a signaling device. If desired, a simple control circuit could also be incorporated with the amplifier 24. That control circuit could measure the amplitude of the signal from the receiver in order to determine if that amplitude met a threshold level before energizing the signal generating device 28.

It is also possible to use a coding and decoding circuit arrangement along with the emergency alarm system as shown in FIGS. 1 and 2. In this case, the signal transmitted from the emergency vehicle, such as the vehicle 10, would be coded in the manner as previously described. A decoder located in the non-emergency vehicle would decode the signal received at the receiver 14. In this case, the encoder could easily be incorporated in and form part of the transmitter in the emergency vehicle. The decoder could be incorporated in and form part of the receiver of the non-emergency vehicle.

In accordance with this system, it would desirable to provide for legislation which requires all vehicles by certain dates to be provided with a system of this type. In this way, if all vehicles operating on public roads were so equipped, it is believed that the rate of accidents with emergency vehicles and the attendant consequences therefrom could be substantially reduced.

FIGS. 3 and 4 of the invention illustrate an embodiment in which there is also a positioning system incorporated with the alarm signal generated inside of the non-emergency vehicle. Referring now to FIG. 3, it can be observed that there is again an emergency vehicle 10 having a transmitter 12 and a non-emergency vehicle 16 having a receiver 14. In this particular embodiment, a global positioning system 34 is also provided for advising the drivers of the non-emergency vehicles of the approximate location of the emergency vehicle operating in an emergency condition. This global positioning system also comprises a satellite 35 shown as being located above the emergency vehicle 10 and the non-emergency vehicle 16 in FIG. 3.

The satellite of the ground positioning system (frequently known as “GPS”) is adapted to pick up a position signal of the emergency vehicle 10. The satellite then transmits a position signal directly to the non-emergency vehicle or non-emergency vehicles in proximity to that emergency vehicle. The satellite would be equipped, for example, with a control system which would detect those non-emergency vehicles which were within a certain radius to the emergency vehicle and cause energization of the alarm systems in those non-emergency vehicles which were within a preselected distance of the emergency vehicle. In like manner, the alarm system within the non-emergency vehicle would not be energized or activated if the non-emergency vehicle were not within a reasonable proximity of the emergency vehicle. In this case, even though a global positioning signal could be generated to a wide area, the global positioning signal in the non-emergency vehicle would not be activated and displayed unless the alarm itself was activated.

If desired, and in order to simplify the cost and size of the receiver system in the non-emergency vehicle, it is also possible to have a ground positioning signal from the satellite 34 transmitted to a central station which would include the necessary control system. This central station would thereupon generate a signal and which would be responsive to those non-emergency vehicles within a preselected radius to the emergency vehicle.

FIG. 4 illustrates an embodiment of a dashboard of a vehicle which is equipped with the system of FIG. 3 for alerting the driver of the non-emergency vehicle 16, both to the presence of an emergency vehicle 10 operating in an emergency condition, and also of the approximate location of that emergency vehicle. Referring now to FIG. 4, it can be observed that there is a receiver 14 mounted on the dashboard of the non-emergency vehicle 16 along with a control unit 40. The control unit receives an electrical signal from the receiver 14 and transmits same to a monitor 42 having a display screen 44 along with a sound or light signal generating device 46. The control unit 40 in this case would be connected through an electrical conductor 48 to the receiver 14 and the control unit would similarly be connected to the monitor 42 through another electrical conductor 50.

It should be recognized that the control unit 40 in this case would incorporate those components in the previous control unit of the previously described embodiment for energization of either a light or sound emergency alarm signal. Again, that alarm system could adopt the form of a simple amplifier 24 for amplifying the signal from the receiver 14.

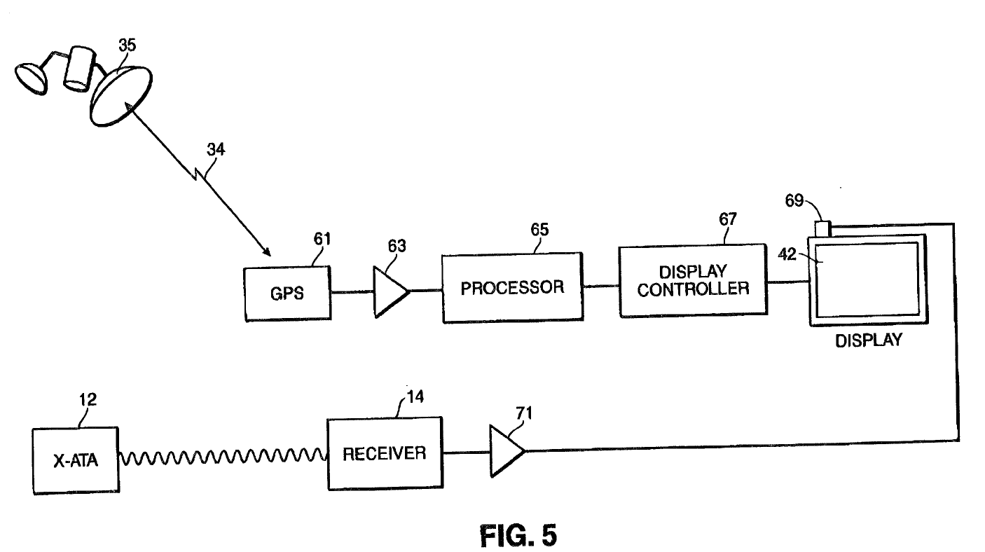

FIG. 5 illustrates a simplified electrical circuit used with the system of FIGS. 3 and 4. In this case, the transmitter 12 and the receiver or receivers 14 are shown along with a ground positioning system satellite 34. The circuit of FIG. 5 includes a ground positioning system controller 61 which receives the signal from the ground positioning satellite 34 and amplifies that signal in an amplifier 63. The signal from the amplifier 63 is introduced into a processor 65 which possesses the GPS signal in order to determine the location of the emergency vehicle. This processor and ground positioning system is conventional in arrangement and is therefore neither illustrated nor described in any further detail herein.

The output of the processor 65 is then introduced into a display controller 67 which processes the signal from the processor 65 for proper display on the monitor 42.

An emergency vehicle approach signaling device 69 is mounted on the monitor 42 and, again, may be in the form of a light or sound generator. This approach signaling device 69 receives a signal from the receiver 14 and which is again amplified through an amplifier 71.

It should be understood that the control circuit of FIG. 5 is a basic and rudimentary control circuit which illustrates the overall components desired for possible inclusion in the system of FIGS. 3 and 4. However, it should also be understood that other circuit modifications and other circuit arrangements could be used, as well.

In accordance with the above-identified construction, it can be observed that the display monitor 42 will display the approximate position of the emergency vehicle operating in an emergency condition and will also simultaneously therewith generate an alarm signal advising the driver of the non-emergency vehicle of the presence of an emergency vehicle in proximity thereto.

FIG. 7 illustrates one form of transmitter, such as a 418 milihertz transmitter which may be used with the present invention and would replace the transmitter 12. This transmitter 60 is comprised of an input line 62 and which is connected across a pair of resistors 64 and 66 to a main transistor 68. The input 62 is connected through a grounded compacitor 70, in the manner as shown in FIG. 7. Moreover, a tuner 72 is connected across the input line 62 and to the gate of the transistor 68.

The input line 62 would receive an output signal of a coding circuit, as hereinafter described. In this way, the input signal would be properly coded before being transmitted. In this respect, the tuner 72 is effective to provide a proper frequency to the output signal from the transmitter 60, as hereinafter described.

The collector of the transistor 68 is also biased through a control voltage over a control voltage line 74 and which is also connected through an inductive coil 76 to the transistor 68. Moreover, the control voltage line 74 is similarly provided with a grounded capacitor 78. The tuner 72 is also ground, in the manner as shown, and the emitter of the transistor 68 is similarly grounded through is resister 80.

The emitter and the collector of the transistor 68 are both connected across an output line 82 and which is similarly connected to grounding capacitors 84. The output of the conductor thereupon provides the desired output signal which is of a proper frequency and which has already been coded. The transmitter 60 is connected to a receiver, such as the receiver 14. For this purpose, any conventional receiver can be used and is therefore neither illustrated nor described in any further detail herein.

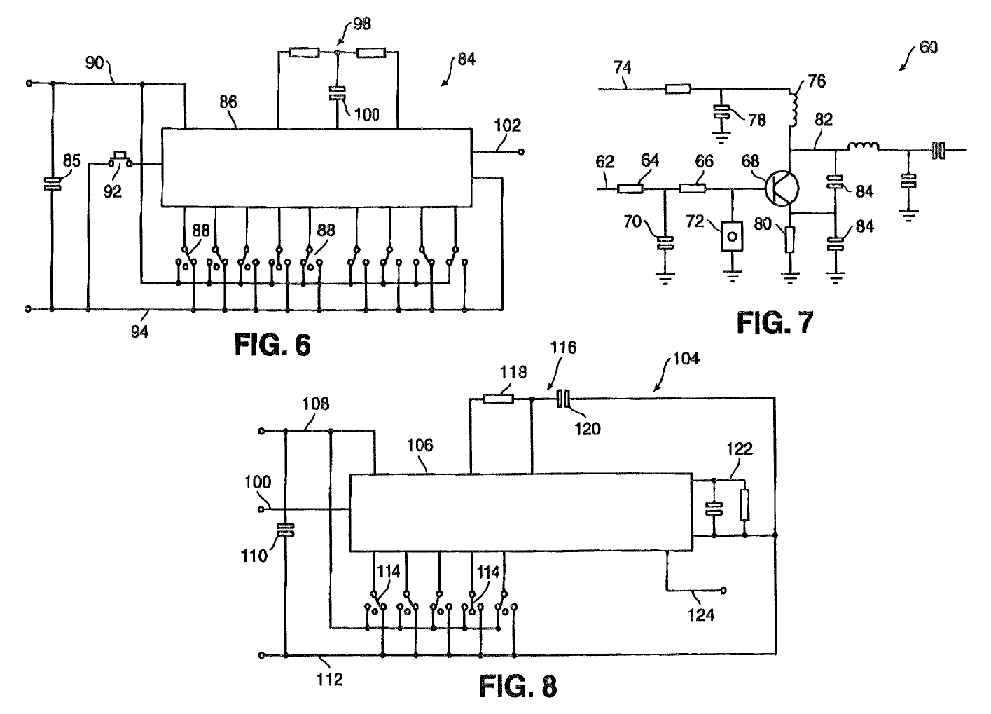

As indicated previously, the input signal on the input signal line 62 of the transmitter has already been coded through a coding circuit 84, as shown in FIG. 6, and which is comprised of a coding chip 86, such as an MCI 145026 encoding chip. Chips of this type are generally conventional and are designed to provide a proper code to the output from the encoding circuit 84. Moreover, a plurality of manually controllable switches 88 are provided so that the operator or the manufacturer of the encoding circuit can set the proper output code.

An input voltage is provided to the coding chip 86 over an input line 90. A transmit switch 92 is similarly connected to the coding circuit and is grounded to a ground line 94. When the switch 92 is closed, it will cause a power signal to be provided to the coding chip 86. The input power signal is also connected through a capacitor 85 to the ground line 94.

Referring again to FIG. 6, a voltage dividing network 98 is connected across the coding circuit along with a capacitor 100, also as shown in FIG. 6. The coding chip 86 provides an output 102 and which would be, in turn, connected to the input line 62 of the transmitter. As indicated, the coding circuit will provide a proper code to the output signal so that only receivers for the alarm system of the invention would be operable by an output signal from the transmitter over the output line 82.

The receiver, such as the receiver 14, would similarly operate with a decoding circuit. In this case, the decoding circuit would be located at the output of the receiver. Thus, as the receiver receives the signal from the transmitter, that signal is then decoded in order to determine if it is a proper signal for purposes of initiating an alarm. Obviously, if it is not a proper signal, it does not pass through the decoder. However, if the signal is one which is designed for the alarm system, it will pass through the decoder, in a manner as hereinafter described.

A decoder 104 is best shown in FIG. 8 of the drawings and comprises a conventional decoding chip 106, such as an MCI 145027 decoding chip. The coding chip 106 receives an input power source over an input line 108 from the receiver. In this case, the power signal over the line 108 is connected through a compacitor 110 through a ground line 112. The capacitor 110 in this case serves as a type of filtering capacitor.

The decoding chip 106 is similarly provided with manually actuable switches 114, similar to the switches 88 used in the coding chip. Here again, these switches allow for the manufacturer or operating technician to set the switches to thereby conform to the output over the output line 102 from the coding chip 86.

The switches 114 are also connected to the chip 106 through an RC circuit 116 comprised of a resister 118 and capacitor 120. Moreover, a similar RC circuit 122 is connected across the chip 106, also in the manner as shown in FIG. 8 of the drawings.

When the decoding chip has determined whether or not the signal which is received at the transmitter is a proper signal for the circuit, it will provide an output signal over a valid transmission line 124. This signal on the valid transmission line is thereupon connected to the alarm of the present invention. Obviously, if the decoder does not detect a proper signal, then no transmission occurs.

It can be seen that the system of the present invention would constitute a highly effective and safe warning system for warning the drivers of non-emergency vehicles about the close proximity of an approaching emergency vehicle. The system can be effective inasmuch as it can provide either a blinking light or other type of light which identifies an approaching emergency vehicle or a sound system, or both. Moreover, radio interference is avoided since the signal from the transmitter would only be properly coded for the signal by the alarm system. As a result, the system would not create any type of interference and would be effective for use.

The system of the invention is designed so that it can actually be incorporated into a small control box mounted at or near the dashboard of an existing vehicle and easily and simply connected to the power source of that vehicle. Otherwise, it can be built into an new automobile construction. In either case, the components forming part of the basic system are relatively few and inexpensive.

Further, the global positioning system can be an optional add on feature. Although not necessary, it would completely apprise the driver of at least location and direction of the approaching emergency vehicle.

Thus, there has been illustrated and described a unique and novel alarm system responding to presence of an emergency vehicle and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by letters patent is:

1. An emergency vehicle alarm system for alerting a driver of a non-emergency vehicle about the close proximity of an emergency vehicle operating under emergency conditions, said system comprising:
a) transceiver means comprising a transmitter for causing generation of an alarm signal which is capable of being detected by the non-emergency vehicle when the emergency vehicle is operating under an emergency condition; and
b) an alarm means located in a non-emergency vehicle and which is actuated to generate an alarm for apprising the operating of the non-emergency vehicle of the approaching emergency vehicle.

2. The emergency vehicle alarm system of claim 1 further characterized in that said transceiver means comprises a transmitter located in the emergency vehicle and a receiver located in the non-emergency vehicle.

3. The emergency vehicle alarm system of claim 1 further characterized in that said alarm means generates an alarm selected from the class consisting of a visual alarm, an audible alarm, or a combination audible visual alarm.

4. The emergency vehicle alarm system of claim 1 further characterized in that said system comprises a coding and decoding circuit arrangement, such that the alarm means is only properly actuated when a coded signal from the transmitter is received by the receiver and decoded and determined if it is a properly coded signal.

5. The emergency vehicle alarm system of claim 1 further characterized in that a global positioning system operates in conjunction with the vehicle alarm system and provides indication of the presence of an approaching emergency vehicle.

6. The emergency vehicle alarm system of claim 1 further characterized in that a tuner is associated with said receiver for providing a properly encoded signal at a desired frequency to constitute an alarm signal.

7. A method for detecting and advising a driver of a non-emergency vehicle of an approaching emergency vehicle operating under an emergency condition, said method comprising:
a) causing the generation of an emergency signal from the emergency vehicle;
b) receiving the emergency signal at a receiver in the non-emergency vehicle; and
c) generating an alarm upon receipt of the emergency signal from the emergency vehicle to apprise the driver of the non-emergency vehicle of the proximity of the emergency vehicle.

8. The method of claim 7 further characterized in that said method comprises generating an alarm selected from the class consisting of a visual alarm, an audible alarm, or a combination audible-visual alarm

9. The method of claim 7 further characterized in that said method comprises generating a display on a monitor in the non-emergency vehicle which shows an illustration of the emergency vehicle in relationship to the non-emergency vehicle in which the monitor is installed.

10. The method of claim 7 further characterized in that said method comprises coding the emergency alarm signal from the emergency vehicle and decoding the signal from the emergency vehicle at the non-emergency vehicle in order to determine if it is a proper alarm signal.

11. An emergency vehicle alarm system for alerting a driver of a non-emergency vehicle about the close proximity of an emergency vehicle operating under emergency conditions, said system comprising:
a) a transmitter located at said emergency vehicle and broadcasting a signal of an emergency condition to non-emergency vehicles in the proximity of said emergency vehicle;
b) means for properly coding the signal which is broadcast by the transmitting means;
c) a receiver located in at least one of said non-emergency vehicles in the proximity of the emergency vehicle;
d) decoding means at said receiver and determining if the signal received by the receiver is a proper signal from the transmitter; and
e) means operatively connected to said receiver and decoding means for generating an alarm signal in response to receipt of a signal from the emergency vehicle.

12. The vehicle emergency alarm system of claim 11 further characterized in that said transmitter broadcasts a wireless signal and said receiver is responsive to that wireless signal.

13. The vehicle emergency alarm system of claim 11 further characterized in that an amplifier is connected to said receiver for amplifying the received signal broadcast from the emergency vehicle.

14. The vehicle emergency alarm system of claim 13 further characterized in that a global positioning receiver receives global positioning data with regard to the location of said emergency vehicle, and a monitor displays the relative positions of the emergency and non-emergency vehicles.
